(19) United States
(12) Patent Application Publication
(10) Pub. No.: US 2024/0346320 A1
(43) Pub. Date: Oct. 17, 2024

(54) TRAINING MODULATOR/SELECTOR HARDWARE LOGIC FOR MACHINE LEARNING DEVICES

(71) Applicant: Rain Neuromorphics Inc., San Francisco, CA (US)

(72) Inventor: Cagri Eryilmaz, Austin, TX (US)

(21) Appl. No.: 18/616,068

(22) Filed: Mar. 25, 2024

Related U.S. Application Data
(60) Provisional application No. 63/454,924, filed on Mar. 27, 2023.

(51) Int. Cl. G06N 3/084

(52) U.S. Cl. CPC G06N 3/084

(57) ABSTRACT

A learning system is described. The learning system includes multiple cores and at least one processor. The cores may perform operations. The processor(s) implement a core selection scheme whereby a subset of the plurality of cores is selected on which at least one operation is to be performed. The processor(s) also implement an operation selection scheme whereby a subset of the operations is selected for each core in the subset of the plurality of cores. Each core in the subset of the plurality cores performs the subset of the operations selected.

### CROSS REFERENCE TO OTHER APPLICATIONS

This application claims priority to U.S. Provisional Patent Application No. 63/454,924 entitled A TRAINING MODULATOR/SELECTOR HW LOGIC FOR MACHINE LEARNING EDGE DEVICES filed Mar. 27, 2023 which is incorporated herein by reference for all purposes.

### BACKGROUND OF THE INVENTION

Artificial intelligence (AI), or machine learning, utilizes learning networks loosely inspired by the brain in order to solve problems. Learning networks, such as deep neural networks, typically include layers of weights that weight signals (mimicking synapses) interleaved with activation layers that apply activation functions to the signals (mimicking neurons). Neurons in the activation layer operate on the weighted input signals by applying some activation function and provide output signals corresponding to the statuses of the neurons. The output signals from the activation layer are provided as input signals to the next weight layer, if any. This process may be repeated for the layers of the network. Learning networks are thus able to reduce complex problems to a set of weights and the applied activation functions. The structure of the network (e.g., number of layers, connectivity among the layers, dimensionality of the layers, the type of activation function, etc.) are together known as a model. Learning networks can leverage hardware, such as graphics processing units (GPUs) and/or AI accelerators, which perform operations usable in machine learning in parallel.

In order to be used in data-heavy tasks and/or other applications, the learning network is trained. Training involves determining an optimal (or near optimal) configuration of the high-dimensional and nonlinear set of weights. Supervised training may include evaluating the final output signals of the last layer of the learning network based on a set of target outputs (e.g., the desired output signals) for a given set of input signals and adjusting the weights in one or more layers to improve the correlation between the output signals for the learning network and the target outputs. For example, backpropagation may be used to adjust the weights. Once the correlation is sufficiently high, training may be considered complete. The model can then be deployed for use.

Although training can result in a learning network capable of solving challenging problems, further optimization of training may be desired. For example, power may be desired to be conserved during training or use of the learning network. Thus, additional improvements are desired.

### BRIEF DESCRIPTION OF THE DRAWINGS

Various embodiments of the invention are disclosed in the following detailed description and the accompanying drawings.

FIG. 1 is a diagram depicting an embodiment of a learning system that may employ modulation during training.

FIG. 2 is a diagram depicting an embodiment of a learning system that may employ modulation during training.

FIGS. 3A-3B are diagrams depicting an embodiment of a learning system-on-a-chip that may employ modulation during training.

FIG. 4 is a flow chart depicting an embodiment of a method for providing modulation of a learning system during training.

FIG. 5 is a flow chart depicting an embodiment of a method for selecting cores to perform modulation during training.

FIG. 6 is a diagram depicting an embodiment of a technique for selecting cores to perform modulation during training.

FIG. 7 is a diagram depicting an embodiment of a technique for selecting cores to perform modulation during training.

FIG. 8 is a diagram depicting an embodiment of a technique for selecting cores to perform modulation during training.

FIG. 9 depicts an embodiment of an operation selection scheme.

FIG. 10 is a diagram depicting one embodiment of the selected and enabled cores.

FIG. 11 is a diagram depicting one embodiment of the selected and enabled cores.

FIG. 12 is a flow chart depicting an embodiment of a method for performing modulated training of a learning network.

FIG. 13 is a diagram indicating the process for an embodiment of a method for performing modulated training of a learning network.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A learning system is described. The learning system includes multiple cores and at least one processor. The cores may perform operations. The processor(s) implement a core selection scheme whereby a subset of the plurality of cores is selected on which at least one operation is to be performed. The processor(s) also implement an operation selection scheme whereby a subset of the operations is selected for each core in the subset of the plurality of cores. Each core in the subset of the plurality cores performs the subset of the operations selected. In some embodiments, the cores operate in epochs. An epoch includes the cores performing forward propagation, determination of weight updates for the cores (e.g. via back propagation), and each core in the subset of cores performing the subset of the operations.

The operations may include a weight update of weights stored for a core, a transpose of the weights stored for the core, and/or a matrix multiplication of the plurality of weights stored for the core by a vector and/or a matrix. In some embodiments, the learning system also includes junction logic modules interconnecting the cores. The junction logic modules selectively enable the subset of the plurality of cores selected by the processor(s). In some embodiments, the cores include at least one of accelerator cores, graphics processing units, or tiles. Each of the tiles includes compute engines. Each compute engine has a compute-in-memory (CIM) hardware module. The CIM hardware module includes storage cells storing elements for a matrix and are configured to perform in parallel vector-matrix multiplication operations for the elements.

In some embodiments, the operation selection scheme is a Lindenmayer selection scheme. For example, the Lindenmayer selection scheme may be an evolutionary scheme. In such an evolutionary scheme, a first selection of a core as a part of the subset of the cores by the core selection scheme results in the core performing a first set of the operations in the Lindenmayer selection scheme. A subsequent selection of the core as the part of the subset of cores by the core selection scheme results in the core performing a next set of operations of the Lindenmayer selection scheme. Thus, the operation(s) performed by a core evolve each time the core is selected. In other embodiments, the Lindenmayer selection scheme is such that a first selection of a first core as a first part of the subset of cores by the core selection scheme results in the first core performing a first set of the operations in the Lindenmayer selection scheme. A next selection of a next core as a next part of the subset of the plurality of cores by the core selection scheme results in the next core performing a next set of operations of the Lindenmayer selection scheme. Thus, the selection scheme evolves core-by-core.

The cores selected by the core selection scheme may depend upon initial conditions, such as the initial subset of cores selected. Thus, an initial subset of cores selected for the core selection scheme may be based on random number generation. In some embodiments, the random number generation is based on hardware properties of the plurality of cores.

A learning system-on-a-chip (SoC) is described. The SoC includes cores, master controller(s), and junction logic modules. The operations may be performed by the cores. The master controller is configured to implement a core selection scheme and an operation selection scheme. The core selection scheme selects a subset of the cores. The operation selection scheme selects a subset of the operations for each core in the subset of cores. The initial conditions for the core selection scheme are based on random number generation, which is based on hardware properties of the cores. The junction logic modules interconnect the cores and selectively enable the subset of the cores selected by the master controller(s). Thus, each core of the subset of cores performs the subset of the operations. The cores may be configured to operate in epochs. An epoch includes the cores performing forward propagation, back propagation being performed for the cores, and each core in the subset of the cores performing the subset of the operations for at least one iteration. The cores may include at least one of accelerator cores, graphics processing units, or tiles. Each tile includes compute engines. Each compute engine has a compute-in-memory (CIM) hardware module that includes a plurality of storage cells that store elements for a matrix and is configured to perform in parallel a plurality of vector-matrix multiplication operations for the elements.

The operation selection scheme may be a Lindenmayer selection scheme configured as an evolutionary scheme. Thus, a first selection of a core as a part of the subset of the plurality of cores by the core selection scheme results in the core performing a first set of the operations in the Lindenmayer selection scheme and a subsequent selection of the core as the part of the subset of the plurality of cores by the core selection scheme results in the core performing a next set of operations of the Lindenmayer selection scheme. In some embodiments, the operation selection scheme is a Lindenmayer selection scheme configured such that a first selection of a first core as a first part of the subset of the plurality of cores by the core selection scheme results in the first core performing a first set of the operations in the Lindenmayer selection scheme and a next selection of a next core as a next part of the subset of the plurality of cores by the core selection scheme results in the next core performing a next set of operations of the Lindenmayer selection scheme. The operations may include a weight update of weights stored for a core, a transpose of the weights stored for the core, and a matrix multiplication of the weights stored for the core by at least one of a vector or a matrix.

A method is described. The method may be used to modulate training of a learning system. The method includes selecting a subset of cores using a core selection scheme. The cores may perform various operations. A subset of the operations for each core of the subset of cores is selected using an operation selection scheme. Each core in the subset of cores performs the subset of the operations for at least one iteration. In some embodiments, the operation selection scheme is a Lindenmayer selection scheme. In some such embodiments, the Lindenmayer selection scheme may be an evolutionary scheme. Thus, a first selection of a core as a part of the subset of cores by the core selection scheme results in the core performing a first set of the operations in the Lindenmayer selection scheme and a subsequent selection of the core as the part of the subset of cores by the core selection scheme results in the core performing a next set of operations of the Lindenmayer selection scheme. In some embodiments, the operation selection scheme is a Lindenmayer selection scheme configured such that a first selection of a first core as a first part of the subset of the plurality of cores by the core selection scheme results in the first core performing a first set of the operations in the Lindenmayer selection scheme and a next selection of a next core as a next part of the subset of the plurality of cores by the core selection scheme results in the next core performing a next set of operations of the Lindenmayer selection scheme.

The method may also include performing an inference using the plurality of cores and determining weight updates (e.g. determination of a gradient of a loss function with respect to the weights and updates to the weights, which may be done via back propagation) for the cores. In such embodiments, the inference and weight update determination are performed before the performing, by each core in the subset of cores, the subset of the operations for at least one iteration occurs. The selection of the subset of cores, the selection of the subset of the operations, the inference, the weight update determination, and the performing the subset of the operations at least once may be within an epoch. In some such embodiments, the method further includes repeating the performing the inference, the determining the weight updates, the selecting the subset of the plurality of cores, the selecting the subset of the operations, and the performing the subset of the operations at least once for another epoch.

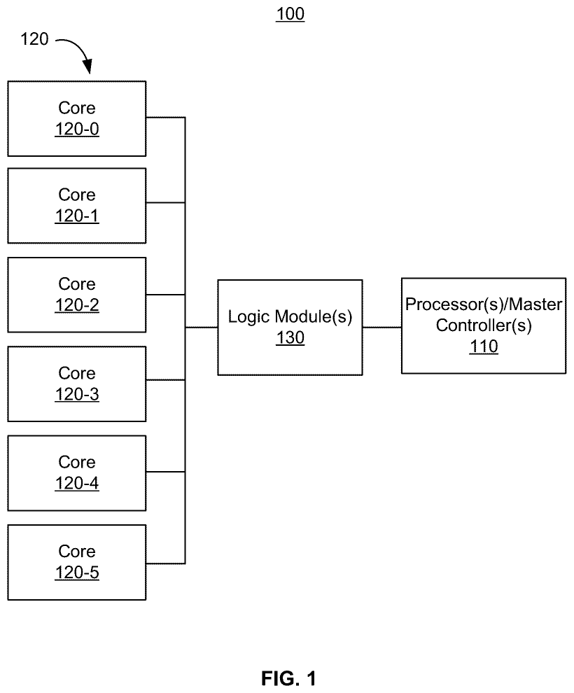

FIG. 1 is a diagram depicting an embodiment of learning system 100 that may employ modulation during training. Learning system 100 includes processor(s) 110, logic module(s) 130, and cores 120-0 through 120-5 (collectively or generically core(s) 120). For clarity, only some portions of learning system 100 may be shown. Although five cores 120 are shown, another number may be present. For example, a larger number of cores 120 may generally be used.

Processor(s) 110 may be or include a processing unit such as a central processing unit of a host, a graphics processing unit, a general-purpose processing unit (e.g. a RISC or ARM processor), or a special-purpose controller. Processor 110 may be considered a master controller for modulation of training and/or use of learning system 100. Processor(s) 110 thus select cores 120 to perform particular operations during training as well as the particular operations performed. Thus, processor(s) 110 may implement a core selection scheme and/or an operation selection scheme. The core selection scheme identifies a subset of cores 120 that is enabled during a particular portion of training. The operation selection scheme identifies a subset of operations that each of the subset of cores 120 (i.e. core(s) 120 that are enabled) implements during training. The operations are those that relate to training of a model for artificial intelligence (e.g. related to the weights stored, the activation functions used, and/or operations performed during training). In some embodiments, processor(s) 110 may reside on a host or a separate system from cores 120 and logic module(s) 130. In such a case, processor(s) 110 provide the subset of cores and subset of operation(s) to logic module(s) 130 and/or cores 120. For example, learning system 100 may include a memory (not shown) at which the selected cores and operations are stored. Although depicted as being coupled to core(s) 120 through logic module(s) 130, processor(s) 110 may be directly connected to one or more cores 120.

Logic module(s) 130 are coupled with processor(s) 110 and cores 120. Logic module(s) 130 receive the subset of cores and subset of operations from processor(s) 110 and selectively enable core(s) 120 that are part of the subset. Logic module(s) 130 may also provide to the enabled core(s) 120 the operation(s) to be performed. In some embodiments, logic module(s) 130 may be part of cores 120. In some embodiments, logic module(s) 130 may be combined with processor(s) 120 in a control system. In some embodiments, logic modules 130 may reside at junctions in a network connecting cores 120. For example, junction module(s) 130 may be junction logic modules that may be part of a mesh stop and/or router.

Cores 120 are artificial intelligence accelerators. Cores 120 are configured to perform, efficiently and in parallel, tasks that may be part of using (e.g. performing inferences) and/or training (e.g. performing inferences and/or updating weights) a model used in machine learning. Cores 120 may perform vector-matrix multiplications (VMMs) and/or apply activation function(s) (e.g. a ReLu, tanh, and/or SoftMax) to data (e.g. the output of a VMM operation). Thus, cores 120 may perform linear and nonlinear operations. In some embodiments, cores 120 may be graphics processing units, tiles, and/or other artificial intelligence accelerator cores. Such tiles may include compute engines and a general-purpose (GP) processor such as a RISC V or ARM processor. Each compute engine may have a compute-in-memory (CIM) hardware module. The CIM hardware module includes storage cells storing elements for a matrix and are configured to perform in parallel VMM operations for the elements. The CIM hardware module performs VMM operations between a vector input to the CIM and the weight matrix. Thus, the CIM hardware module performs linear operations. The GP processor may perform nonlinear functions such as applying activation functions to vectors. In some embodiments, such compute engines also include local update modules, which allow for updates of weights to be performed within the compute engine. In some embodiments, the tile may also include a local, scratchpad memory such as a static random access memory (SRAM).

In operation, processor(s) 110 implement a core selection scheme that selects a subset of cores 120 to perform operations. Stated differently, the core selection scheme identifies a subset of cores 120 that will be enabled. Processor(s) 110 also implement an operation selection scheme that selects a subset of operations for each of the enabled cores. The operations may include a weight update of weights stored for a core 120, a transpose of the weights stored for the core 120, and/or a matrix multiplication of the plurality of weights stored for the core 120 by a vector and/or a matrix. The operations from which the subset may be selected may be limited to those operations performable by cores 120. Thus, the enabled core(s) 120 and the operation(s) performed by each enabled core 120 are identified. Each of the enabled core(s) 120 performs the corresponding subset of operations. To do so, logic module(s) 130 selectively enable cores 120 in the subset of cores to perform their subset of operations. Logic module(s) 130 also selectively disable cores 120 not in the subset from performing the operations.

Each core 120 in a subset performing the subset of operations selected may occur during training. For example, an epoch of training may include an inference (i.e. forward propagation of training data for learning system 100), a determination of the updates to weights stored in cores 120 (e.g. via backpropagation), and the subset of cores 120 performing the subset of operations on each core 120. In some embodiments, a weight update is performed for all cores 120 in addition to each core of the subset of cores 120 performing a subset of operations. In some embodiments, the epoch includes multiple iterations of each core in the subsets of cores 120 performing the subset of operations. In such embodiments, a new subset of cores 120 and a subset of operations for each core in the subset may be provided for each iteration.

The performance of the subset of operations by each of the subset of cores 120 may be considered modulation of the training of learning system 100. For example, only some of the cores 120 may perform a weight update (one of the possible operations in a subset), may perform a weight transpose in addition to or in lieu of a weight update, and/or may perform an VMM of the weights. Thus, not all cores 120 may perform the same operation. Consequently, training of learning system 100 is modulated.

Performance of learning system 100 may be improved. Because only a subset of cores 120 are enabled, less power may be consumed by learning system 100 during training. Consequently, learning system 100 may be less power hungry than a conventional system. Further, through the selection of cores 120 and/or operations in the corresponding subsets, additional order may be imposed on learning system 100 and the model being provided during training. For example, the selection of cores 120 may be based in full or in part by physical characteristics of the semiconductor device(s) on which cores 120 are fabricated. This may occur by using the leakage current, dopant densities, and/or other properties of the semiconductor device in the core selection scheme. As a result, training may reflect the inherent characteristics of the hardware used in learning system 100 in addition to the characteristics of the training data and/or software used in conjunction with learning system 100. Moreover, a natural growth (or other) model may be used in selecting the operations to be performed. In some cases, a Lindenmayer selection scheme may be used to determine the operation(s) performed by each core 120 in a subset. For example, the cores 120 in a subset may be ordered, with each subsequent core 120 performing the next set of operations in the Lindenmayer progression. Thus, the operations performed by cores 120 evolve core-by-core in a particular epoch. In some cases, a Lindenmayer selection scheme may be used to determine the operation(s) performed by a core 120 each time the core 120 is selected. For example, core 120-1 may perform the first operation in a Lindenmayer progression the first time core 120-1 is selected. Each subsequent selection of core 120-1 to be enabled results in core 120-1 performing the next set of operations in the Lindenmayer progression. The operations performed by a core evolve epoch-by-epoch. Thus, the operations performed by a particular core 120 evolve over time. This allows learning system 100 to have enhanced representation power without adding layers and/or additional parameters to the learning network provided by learning system 100. Consequently, learning system 100 may be better able to perform functions for which learning system is trained.

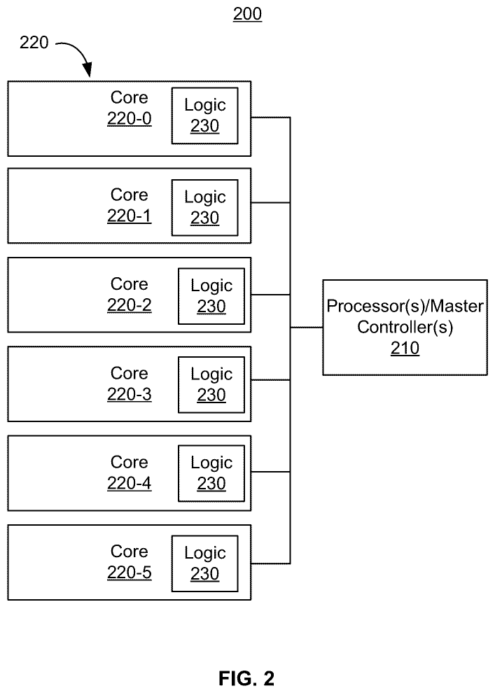

FIG. 2 is a diagram depicting an embodiment of learning system 200 that may employ modulation during training. Learning system 200 is analogous to learning system 100. Learning system 200 includes processor(s) 210, logic module(s) 230, and cores 220-0 through 220-5 (collectively or generically core(s) 220) that are analogous to processor(s) 110, logic module(s) 130, and cores 120. For clarity, only some portions of learning system 200 may be shown. Although five cores 220 are shown, another number may be present. For example, a larger number of cores 220 may generally be used. In learning system 200, however, logic modules 230 reside within corresponding cores 220. Thus, each core 220 has a dedicated logic module 230 that controls whether the corresponding core 220 is enabled and the operations performed by the core.

Learning system 200 may share the benefits of learning system 100. Because training is modulated (only a subset of cores 220 perform a subset of operations), less power may be consumed by learning system 200 during training. Further, the selection of a subset of cores 220 and/or a subset of operations may provide additional order for learning system 200. Training may reflect the inherent characteristics of the hardware used in learning system 200. A natural growth model such as Lindenmayer (or another model) may be used in selecting the operations to be performed. Learning system 100 may have enhanced representation power. Consequently, learning system 200 may have improved performance.

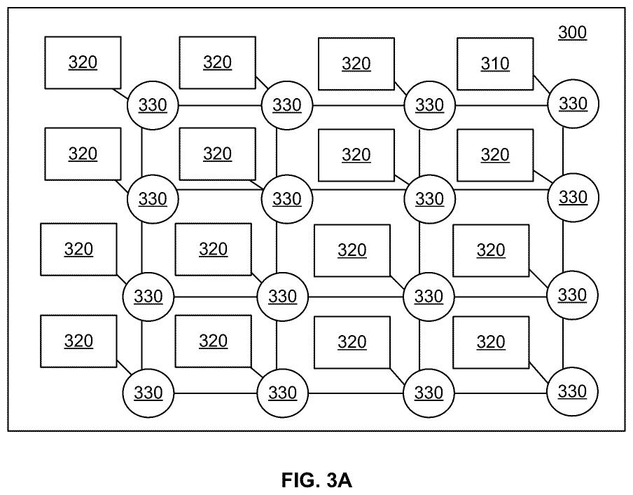

FIGS. 3A-3B are diagrams depicting an embodiment of learning system 300 that may employ modulation during training. Learning system 300 is depicted in FIG. 3A. FIG. 3B depicts an embodiment of a core 320. Learning system 300 is analogous to learning system(s) 100 and/or 200. Learning system 300 includes processor(s) 310, logic modules 330, and cores 320 that are analogous to processor(s) 110/210, logic module(s) 130/230, and cores 120/220. Cores 320 are tiles. Learning system 300 is a learning system-on-a-chip (SoC). For clarity, only some portions of learning SoC 300 may be shown. Although fifteen tiles 320 are shown, another number may be present. For example, a larger number of tiles 320 may generally be present. Although processor 310 is shown, in some embodiments, processor 310 may be separated from tiles 320 and logic modules 330. In such embodiments, another tile may replace processor 310.

In learning SoC 300 logic modules 330 may be junction logic modules 330 that interconnect tiles 320. Junction logic modules 330 may be part of a mesh stop, router, or other mechanism used in managing traffic through the network of SoC 300. Thus, junction logic modules 330 selectively enable tiles 320.

FIG. 3B depicts an embodiment of tile 320. Tile 320 includes compute engines 340-0 through 340-3 (collective or generically compute engines 340), general-purpose processor 350, and memory 360. Other components may be present but are not shown for clarity. Although four compute engines 340 are shown, another number may be present. General-purpose processor 350 may be a reduced instruction set computer (RISC) processor, such as a RISC-V processor or ARM processor. General-purpose processor 350 may perform nonlinear operations (e.g. applying activation functions to vectors) and may control operation of compute engines 340. In some embodiments, data provided to compute engines 340 is routed through general-purpose processor 350. Thus, general purpose-processor 350 may be part of the control and data planes in addition to performing nonlinear operations. However, general-purpose processor 350 is still desired to have reduced functionality as compared to, for example, a graphics processing unit or central processing unit of a computer system with which tile 320 might be used. Memory 360 may be an SRAM and may store, for example, activations (e.g. input vectors, the output of compute engines 340, and/or resultant of general-purpose processor 350 applying activations to output vectors from compute engines 340.

Compute engines 340 are configured to perform VMM operations in parallel. Each compute engine 340-i (where i=0, 1, 2, or 3) includes a compute-in-memory (CIM) hardware module 342-i (collectively or generically CIM module 342) and may include a local update (LU) module 344-i (collectively or generically LU module 344).

CIM module 342 is a hardware module that stores data and performs operations such as VMMs. In some embodiments, CIM module stores weights 342 for the model. In some embodiments, CIM module 342 stores the weights (or other data) in cells that are fully addressable. CIM module 342 also performs VMMs, where the vector may be an input vector (e.g. an activation) provided using general-purpose processor 350 and the matrix may be weights (i.e. data/parameters) stored by CIM module 342. CIM module 342 may be considered to include a memory (e.g. that stores the weights) and compute hardware (e.g. that performs the vector-matrix multiplication of the stored weights). For example, CIM module 342 may include an array of memory cells configured analogous to a crossbar array and adder tree(s). CIM module 342 may include an analog SRAM having multiple SRAM cells and configured to provide output(s) (e.g. voltage(s)) corresponding to the data (weight/parameter) stored in each cell of the SRAM multiplied by a corresponding element of the input vector. In some embodiments, CIM module 342 may include a digital SRAM having multiple SRAM cells and configured to provide output(s) corresponding to the data (weight/parameter) stored in each cell of the digital SRAM multiplied by a corresponding element of the input vector. Other configurations of CIM modules 342 are possible. Each CIM module thus stores weights corresponding to a matrix in its cells and is configured to perform a vector-matrix multiplication of the matrix with an input vector.

LU modules 344 are used to update the weights (or other data) stored in the CIM modules 342. LU modules 344 are considered local because LU modules 344 are in proximity to CIM modules 342. For example, LU module(s) 344 for a particular compute engine 340 may reside in the same integrated circuit as the CIM module(s) 344 for compute engine 340. In some embodiments, the LU module 344 is considered local because it is fabricated on the same substrate (e.g. the same silicon wafer) as the corresponding CIM module 342. In some embodiments, LU modules 344 are also used in determining the weight updates. In other embodiments, a separate component may calculate the weight updates. For example, in addition to or in lieu of LU modules, the weight updates may be determined by general-purpose processor 350, in software by other processor(s) not part of tile 320, by other hardware that is part of tile 320, by other hardware outside of tile 100, and/or some combination thereof.

Learning SoC 300 may share the benefits of learning system(s) 100 and/or 200. Because training is modulated (only a subset of tiles 320 perform a subset of operations), less power may be consumed by learning system 300 during training. Further, the selection of a subset of tiles 320 and/or a subset of operations may provide additional order for learning SoC 300. Training may reflect the inherent characteristics of the hardware used in learning SoC 300. A natural growth model such as Lindenmayer (or another model) may be used in selecting the operations to be performed. Learning SoC 300 may have enhanced representation power. Consequently, learning SoC 300 may have improved performance.

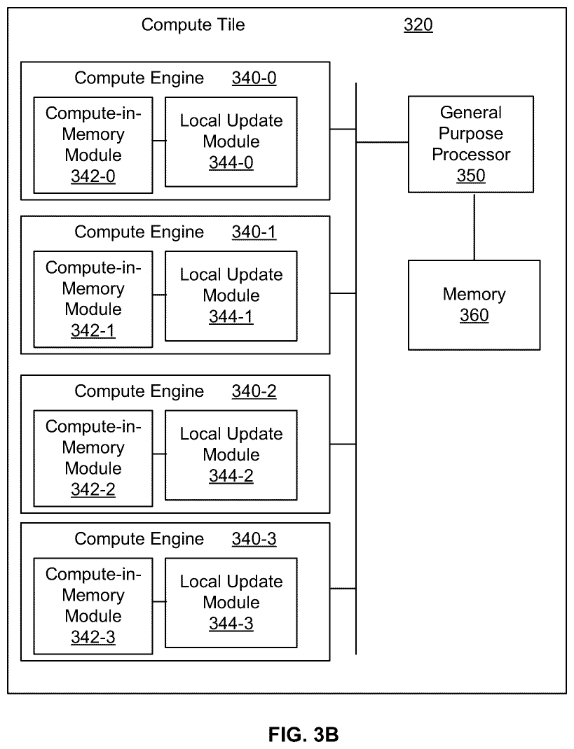

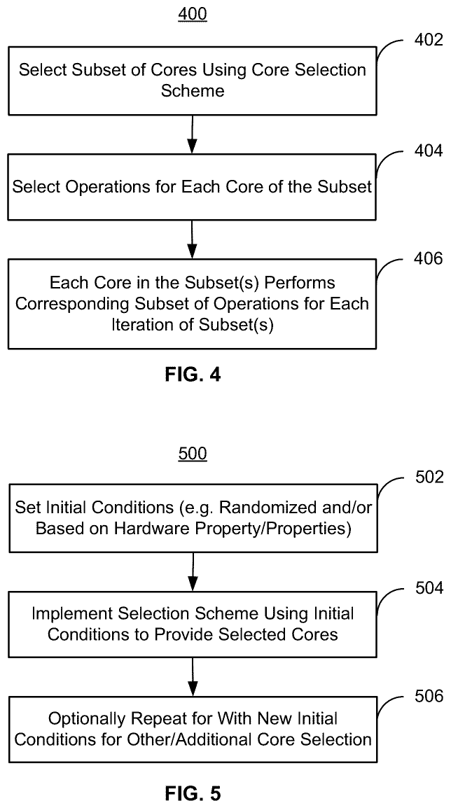

FIG. 4 is a flow chart depicting an embodiment of method 400 for providing modulation of a learning system during training. In some embodiments, portions of method 400 may include substeps and/or may be performed in another order including in parallel. Method 400 is described in the context of learning SoC 300. However, method 400 may be used with other learning systems including but not limited to learning systems 100 and/or 200.

A subset of cores in the learning system is selected using a core selection scheme, at 402. In some embodiments, the core selection scheme used at 402 reflects the underlying properties of hardware in the learning system. 402 may also be performed multiple times in order to select multiple subsets of cores usable in training the learning system. For example, for each subset, 402 may provide an identifier for each core selected, as well as a particular order in which cores are to be enabled. A subset of the operations for each core of a subset of cores is selected using an operation selection scheme, at 404. In some embodiments, 404 selects the subset of operations for each subset of cores selected in 402. At 406, each core in a subset performs its subset of operations. In some embodiments, 406 performs this function multiple times. For example, the functions of 404 may be performed once per epoch for multiple epochs. In some embodiments, the functions of 404 may be performed multiple times per epoch. Although indicated as flowing from 404 to 406, 402 and 404 may be performed at one time and 406 performed at a different time. In addition, other functions may be performed by a learning network between 404 being performed and 406 being performed by core(s) of the learning network.

For example, processor 310 may determine subsets of tiles 320 to be selective enabled at 402. At 404, processor 310 may determine the operations to be performed for each tile 320 in each subset. The identification of the tiles 320 in each subset and the corresponding operations may be provided to junction logic modules 330. During training, junction logic module(s) 330 selectively enable each tile 320 is a subset to perform the operations in the corresponding subset of operations. Thus, between selection of tiles and operations at 402 and 404, a significant amount of time might, but need not, have passed. In addition, at least one inference and determination of the corresponding weight updates for training may have been performed.

Using method 400, performance of a learning system may be improved. Because training is modulated, less power may be consumed by a learning system during training (i.e. using step 406). Further, the selection of a subset of cores at 402 and/or a subset of operations at 404 may provide additional order for the learning system. Training may reflect the inherent characteristics of the hardware used. A natural growth model such as Lindenmayer (or another model) may be used in selecting the operations at 404 to be performed. A learning system may have enhanced representation power. Consequently, a learning system using method 400 may have improved performance.

FIG. 5 is a flow chart depicting an embodiment of method 500 for selecting cores to perform modulation during training. In some embodiments, portions of method 500 may include substeps and/or may be performed in another order including in parallel. In some embodiments, method 500 may be viewed as a particular embodiment of 402 of method 400.

Initial conditions are set, at 502. The cores selected by method 500 may depend upon initial conditions, such as the initial subset of cores selected. In some embodiments, the initial conditions are selected in a randomized manner. For example, an initial subset of cores selected for the core selection scheme may be based on random number generation. In some embodiments, the initial conditions are set based on underlying properties of the hardware for the learning system. In some embodiments, the random number generation is based on hardware properties of the plurality of cores. For example, leakage current, dopant densities, and/or other properties of the cores may be used in determining the initial conditions (e.g. the initial cores selected).

The core selection scheme is implemented using the initial conditions, at 504. For example, the core selection scheme may select next core(s) based on the cores previously selected. In some embodiments, a particular pattern (e.g. a spiral pattern) may be part of the selection scheme. For example, in an array of cores, cores may be selected in a line (vertical, horizontal, or diagonal, or some other pattern) until an edge is reached. The pattern may continue on an opposing edge, the edge may act as a reflector to select the next core, or another pattern may be selected. In some embodiments, 504 continues until a particular endpoint (e.g. a maximum number of cores) is reached. Thus, a subset of cores may be identified. In some embodiments, 502 and 504 are optionally repeated with new initial conditions and/or a different selection scheme to provide other subsets of cores, at 506.

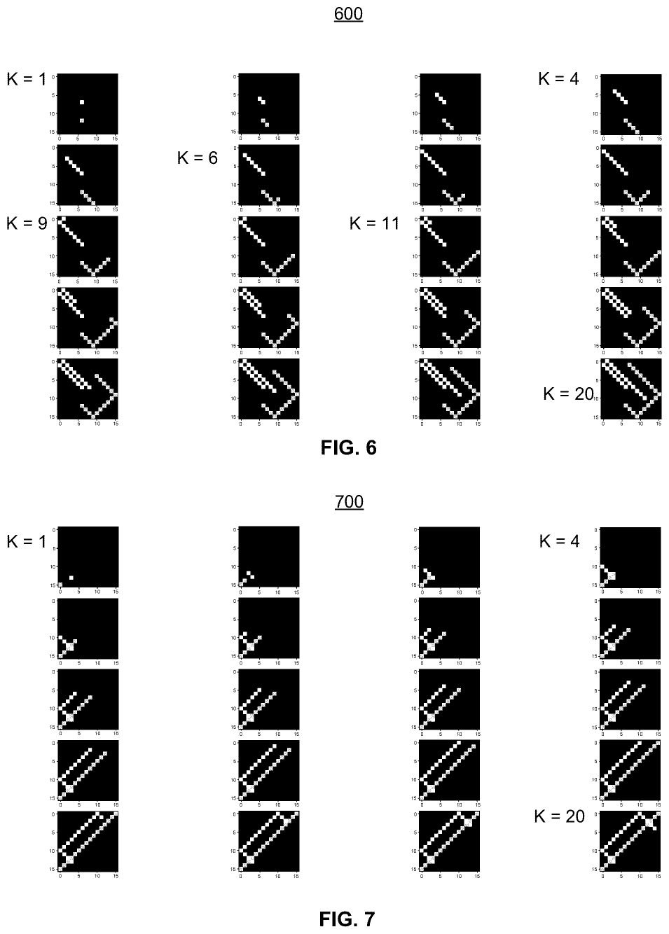

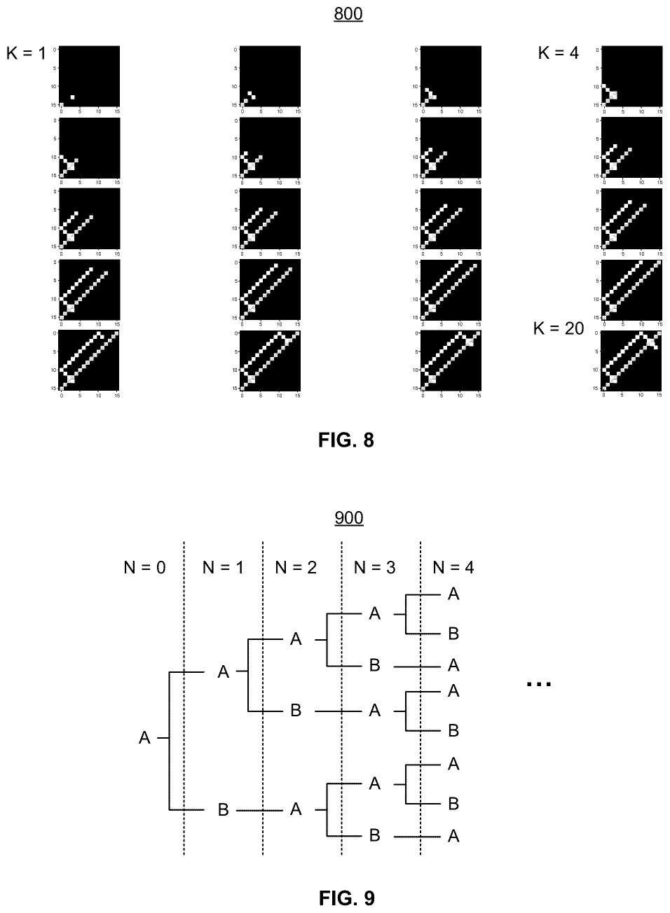

For example, FIG. 6, FIG. 7, and FIG. 8 are diagrams 600, 700, and 800, respectively, depicting an embodiment of techniques for selecting cores using method 500. For diagrams 600, 700, and 800, the same selection scheme is used, but the initial conditions are changed. Each square in diagrams 600, 700 and 800 represents a 16×16 array of cores (i.e. two hundred and fifty-six cores). The lighter regions indicate the cores selected. The selection scheme starts with two cores initially selected at K=1. Two additional cores are selected for K=2 through K=20. The subset of cores is identified by the lighter regions in K=20. The order is indicated by the progression of K=1 through K=20. The lightest regions (green) are cores selected that are further up and to the left of the initial cores selected. The next lightest regions (red) are cores selected that are further down and to the right of the initial cores selected. However, when an edge core is selected, the next core is reflected from the edge (e.g. as shown in K=6, K=9, and K=11).

The initial cores in diagrams 600, 700, and 800 differ. In some embodiments, the initial cores (in K=1 of diagrams 600, 700, and 800) may be randomly selected. For example, selected by a random number generator. In some embodiments, the selection may incorporate characteristics of the hardware for the cores. For example, the random number generator may be provided with a measurement of the leakage current of one or more cores at a particular time, the dopants of one or more of the cores, or another physical property of the cores. Thus, the subset of cores identified in K=20, as well as the order of cores, for each diagram 600, 700, and 800 differ.

Various selection schemes may be used to determine the operations selected for each core at 404. FIG. 9 depicts an embodiment of operation selection scheme 900. Operation selection scheme 900 utilizes a Lindenmayer selection scheme. For selection scheme 900, two possible operations, represented by “A” and “B”, are selected. For example, A may be a weight update, while B may be a matrix transpose. In another example, A may be a matrix multiplication (e.g. an input vector multiplied by the weights in the core), while B may be a matrix transpose. Other operations are possible. The Lindenmayer progression is shown for N=0 through N=4. The maximum value of N may be selected based upon the number of times operations may be performed. For example, if up to twenty sets of operations may be part of a subset, then the maximum value of N may be twenty.

For the Lindenmayer progression, if A is the value at a particular value of N (e.g. n), then A and B are the value for n+1. If B is the value at a particular value of N (e.g. n), then A is the value for n+1. Thus, for N=0, the operation is operation A, for N=1, the operations are A and B, and so on. If the operation for N=0 was B, then the progression would differ from the selection scheme 900. As can be seen in operation selection scheme 900, the number of operations grows for the Lindenmayer selection scheme. This growth pattern corresponds to a natural pattern, which may be desirable for a learning system.

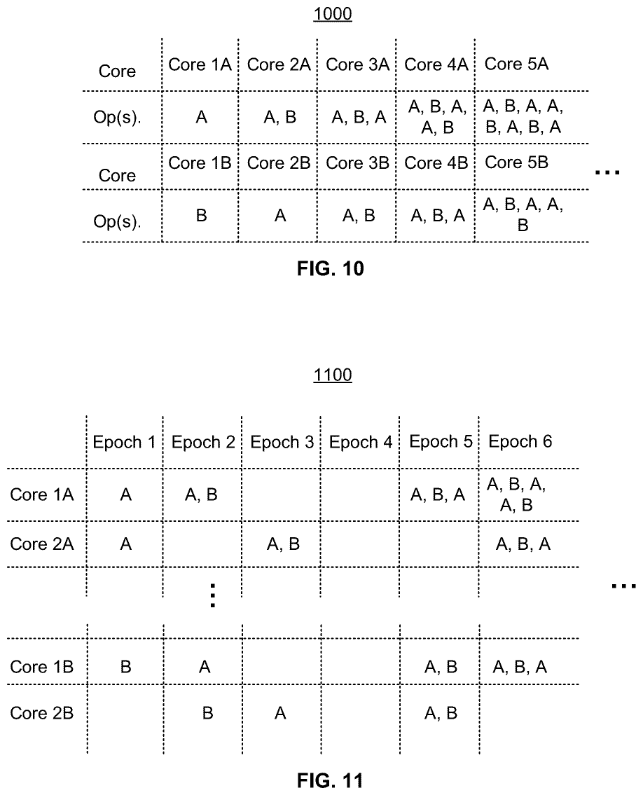

FIG. 10 and FIG. 11 are diagrams 1000 and 1100, respectively, depicting embodiments of the selected and enabled cores for the Lindenmayer selection scheme. Diagram 1000 indicates the Lindenmayer selection scheme used in for corresponding cores for cores selected for a single subset (e.g. in diagram 600). Thus, diagram 1000 shows the operations for each core in a single subset of cores. Cores 1A, 2A, 3A, 4A, 5A, . . . are the lighter (green) cores selected. Cores 1B, 2B, 3B, 4B, 5B, . . . are the less light (red) cores selected. The lighter cores (Core 1A, . . . ) start with operation A. The less light cores (Core 1B, . . . ) start with operation B. Thus, the progression of operations differs for the two sets of cores in this subset. Thus, in diagram 1000, the next core identified for a particular subset of cores (e.g. an epoch) executes more operations. Consequently, the last core in the subset executes are large number of operations.

Diagram 1100 indicates the Lindenmayer selection scheme that is an evolutionary selection scheme. More specifically, the operations performed by a core evolve based on the Lindenmayer progression each time the particular core is enabled. In the example shown, the evolution occurs per epoch. A blank space indicates that the core is not enabled during that epoch. For example, diagram 1100 may be considered to show the operations performed by cores selected in diagrams 600, 700, and 800 for epoch 1, epoch 2, and epoch 3. Thus, diagram 1000 shows the operations for each core in at least six subsets of cores. Cores 1A, 2A . . . are the lighter (green) cores selected in diagrams 600, 700, and 800 (plus additional selection iterations. Cores 1B, 2B, . . . are the less light (red) cores selected in diagrams 600, 700, and 800 (plus additional selection iterations). The lighter cores (Core 1A, . . . ) start with operation A. The less light cores (Core 1B, . . . ) start with operation B. Thus, the progression of operations differs for the two sets of cores. In addition, how the operations performed by each core progress depends upon how frequently the core is enabled (i.e. how many times the core is selected to be part of a subset). Thus, in diagram 1000, the time a particular core is in a subset, the core executes more operations.

Thus, as indicated by diagrams 600, 700, 800, 900, 1000, and 1100, the cores selected and operations performed by cores may be modulated. Consequently, performance of a learning system may be improved. Because training is modulated, less power may be consumed by a learning system during training. Further, training may reflect the inherent characteristics of the hardware used. A learning system may also have enhanced representation power. Consequently, a learning system may have improved performance.

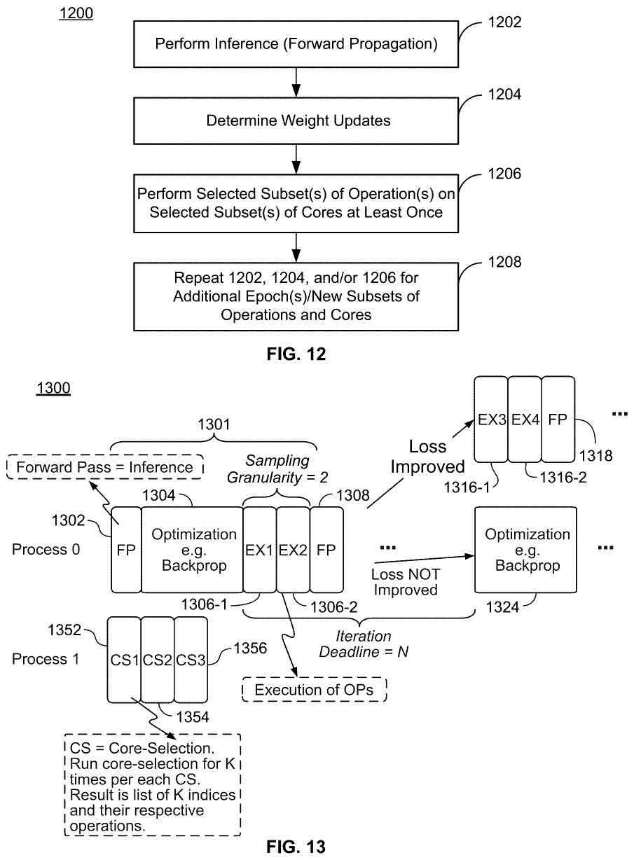

FIG. 12 is a flow chart depicting an embodiment of method 1200 for performing modulated training of a learning network. FIG. 13 is a diagram indicating the process 1300 for an embodiment of a method for performing modulated training of a learning network. In some embodiments, portions of method 1200 may include substeps and/or may be performed in another order including in parallel. Method 1200 is described in the context of flow 1300. However, method 1200 may be used with learning systems including but not limited to learning systems 100, 200, and/or 300. As indicated in flow 1300, the cores may be selected separately, using core selection processes 1352, 1354, and 1356. Core selection processes 1352, 1354, and 1356 may be considered analogous to 402 of method 400.

An inference is performed, at 1202. Thus, training data may be input to the learning system and the output of the learning network determined. Weight updates are determined, at 1204. For example, a loss function may be determined based on the output and the corresponding loss function (e.g. the difference between the output of the learning network and the target output) determined. This may be performed using backpropagation, stochastic gradient descent, equilibrium propagation and/or another technique. Thus, forward pass (i.e., inference) 1302 and optimization/backpropagation 1304 are indicated as part of the first epoch 1301 in flow 1300. Weight updates for the learning network are thus determined.

Each core in a subset performs its subset of operations, at 1206. This may occur one or more times. For example, in flow 1300, the sampling granularity, or number of times subsets of cores execute subsets of operations, is two. Thus, the subset of cores for core selection process 1352 may be used in execution block 1306-1. The subset of cores from core selection process 1354 may be used in execution block 1306-2. The subset of operations executed by each core in each execution block 1306-1 and 1306-2 may differ. For example, the operations may change based on the Lindenmayer progression in a similar manner as shown in diagram 1000 or 1100. Thus, epoch 1301 is completed.

This process may be repeated for additional epochs, at 1208. In such epochs, new subset(s) of cores and/or new subset(s) of operations may be used. This process may be repeated for a particular number of iterations (e.g. iteration deadline=N in flow 1300). It may then be determined (e.g. as part of 1208) whether the loss has improved. For example, an additional forward pass 1308 (inference) is indicated in flow 1300. The loss may be determined from this forward pass 1308. If the loss is reduced, then the process may be continued for a desired amount of time and/or accuracy. This is indicated by additional execution blocks 1316-1 and 1316-2 as well as forward pass 1318. If the loss is not improved, then the weight updates may be recalculated at 1304. Training with modulation may be continued or training without modulation (e.g. all cores simply update weights based) may be performed.

Using method 1200 and flow 1300, performance of a learning system may be improved. Because training is modulated, less power may be consumed by a learning system during training. Further, the selection of a subset of cores and/or a subset of operations may provide additional order for the learning system. Consequently, a learning system using method 1200 and/or flow 1300 may have improved performance.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A learning system, comprising:
a plurality of cores by which operations may be performed;
at least one processor that
implements a core selection scheme whereby a subset of the plurality of cores is selected on which at least one operation is to be performed;
implements an operation selection scheme whereby a subset of the operations is selected for each core in the subset of the plurality of cores; and
wherein each core in the subset of the plurality cores performs the subset of the operations selected.

2. The learning system of claim 1, wherein the operation selection scheme is a Lindenmayer selection scheme.

3. The learning system of claim 2, wherein the Lindenmayer selection scheme is an evolutionary scheme such that a first selection of a core as a part of the subset of the plurality of cores by the core selection scheme results in the core performing a first set of the operations in the Lindenmayer selection scheme and a subsequent selection of the core as the part of the subset of the plurality of cores by the core selection scheme results in the core performing a next set of operations of the Lindenmayer selection scheme.

4. The learning system of claim 2, wherein the Lindenmayer selection scheme is such that a first selection of a first core as a first part of the subset of the plurality of cores by the core selection scheme results in the first core performing a first set of the operations in the Lindenmayer selection scheme and a next selection of a next core as a next part of the subset of the plurality of cores by the core selection scheme results in the next core performing a next set of operations of the Lindenmayer selection scheme.

5. The learning system of claim 1, wherein the core selection scheme includes an initial subset of the plurality of cores selected based on random number generation.

6. The learning system of claim 5, wherein the random number generation is based on hardware properties of the plurality of cores.

7. The learning system of claim 1, wherein the plurality of cores is configured to operate in epochs, an epoch including the plurality of cores performing forward propagation, determination of weight updates for the plurality of cores, and each core in the subset of the plurality of cores performing the subset of the operations.

8. The learning system of claim 1, wherein the operations include a weight update of a plurality of weights stored for a core, a transpose of the plurality of weights stored for the core, and a matrix multiplication of the plurality of weights stored for the core by at least one of a vector or a matrix.

9. The learning system of claim 1, further comprising:
a plurality of junction logic modules interconnecting the plurality of cores, the plurality of junction logic modules selectively enabling the subset of the plurality of cores selected by the at least one processor.

10. The learning system of claim 1, wherein the plurality of cores include at least one of a plurality of accelerator cores, a plurality of graphics processing units, or a plurality of tiles, each of the plurality of tiles including a plurality of compute engines, each of the plurality of compute engines having a compute-in-memory (CIM) hardware module, the CIM hardware module including a plurality of storage cells storing a plurality of elements for a matrix and being configured to perform in parallel a plurality of vector-matrix multiplication operations for the plurality of elements.

11. A learning system-on-a-chip (SoC), comprising:
a plurality of cores by which operations may be performed;
at least one master controller configured to implement a core selection scheme and an operation selection scheme, the core selection scheme being configured to select a subset of the plurality of cores, the operation selection scheme being configured to select a subset of the operations for each core in the subset of the plurality of cores, initial conditions for the core selection scheme being based on random number generation, the random number generation being based on hardware properties of the plurality of cores; and
at least one logic module coupled with the plurality of cores and the at least one master controller, the at least one logic module configured to selectively enable the subset of the plurality of cores selected by the at least one master controller such that each core of the subset of the plurality of cores perform the subset of the operations.

12. The learning SoC of claim 11, wherein the operation selection scheme is a Lindenmayer selection scheme configured as an evolutionary scheme such that a first selection of a core as a part of the subset of the plurality of cores by the core selection scheme results in the core performing a first set of the operations in the Lindenmayer selection scheme and a subsequent selection of the core as the part of the subset of the plurality of cores by the core selection scheme results in the core performing a next set of operations of the Lindenmayer selection scheme.

13. The learning SoC of claim 11, wherein the operation selection scheme is a Lindenmayer selection scheme configured such that a first selection of a first core as a first part of the subset of the plurality of cores by the core selection scheme results in the first core performing a first set of the operations in the Lindenmayer selection scheme and a next selection of a next core as a next part of the subset of the plurality of cores by the core selection scheme results in the next core performing a next set of operations of the Lindenmayer selection scheme.

14. The learning SoC of claim 11, wherein the plurality of cores is configured to operate in epochs, an epoch including performing forward propagation for the plurality of cores, performing back propagation for the plurality of cores, and each core in the subset of the plurality of cores performing the subset of the operations for at least one iteration.

15. The learning SoC of claim 11, wherein the operations include a weight update of a plurality of weights stored for a core, a transpose of the plurality of weights stored for the core, and a matrix multiplication of the plurality of weights stored for the core by at least one of a vector or a matrix.

16. The learning SoC of claim 11, wherein the at least one logic module includes a plurality of junction logic modules interconnecting the plurality of cores and wherein the plurality of cores includes at least one of a plurality of accelerator cores, a plurality of graphics processing units, or a plurality of tiles, each of the plurality of tiles including a plurality of compute engines, each of the plurality of compute engines having a compute-in-memory (CIM) hardware module, the CIM hardware module including a plurality of storage cells storing a plurality of elements for a matrix and being configured to perform in parallel a plurality of vector-matrix multiplication operations for the plurality of elements.

17. A method, comprising:
selecting a subset of a plurality of cores using a core selection scheme, a plurality of operations being performable by the plurality of cores;
selecting a subset of the operations for each core of the subset of the plurality of cores using an operation selection scheme; and
performing, by each core in the subset of the plurality of cores, the subset of the operations for at least one iteration.

18. The method of claim 17, wherein the operation selection scheme is a Lindenmayer selection scheme configured as an evolutionary scheme such that a first selection of a core as a part of the subset of the plurality of cores by the core selection scheme results in the core performing a first set of the operations in the Lindenmayer selection scheme and a subsequent selection of the core as the part of the subset of the plurality of cores by the core selection scheme results in the core performing a next set of operations of the Lindenmayer selection scheme.

19. The method of claim 17, wherein the operation selection scheme is a Lindenmayer selection scheme configured such that a first selection of a first core as a first part of the subset of the plurality of cores by the core selection scheme results in the first core performing a first set of the operations in the Lindenmayer selection scheme and a next selection of a next core as a next part of the subset of the plurality of cores by the core selection scheme results in the next core performing a next set of operations of the Lindenmayer selection scheme.

20. The method of claim 17, further comprising:
performing an inference using the plurality of cores;
determining weight updates for the plurality of cores;
wherein the performing, by each core in the subset of the plurality of cores, the subset of the operations for at least one iteration occurs after the performing the inference and determining the weight updates, wherein the selecting the subset of the plurality of cores, the selecting the subset of the operations, the performing the inference, the determining the weight updates, and the performing the subset of the operations at least once are within an epoch; and wherein the method further includes
repeating the performing the inference, the determining the weight updates, the selecting the subset of the plurality of cores, the selecting the subset of the operations, and the performing the subset of the operations at least once for another epoch.
